(19) United States
(12) Patent Application Publication
(10) Pub. No.: US 2010/0248873 A1
(43) Pub. Date: Sep. 30, 2010

(54) Novelty article with flexible and waterproof display carrying membrane

(76) Inventor: John Scott Cooper, Vista, CA (US)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/383,924

(22) Filed: Mar. 30, 2009

(51) Int. Cl. A63B 43/00; B32B 3/10; B32B 3/30

(52) U.S. Cl. 473/599; 473/596; 428/196; 428/172

(57) ABSTRACT

A novelty article comprises a flexible and waterproof display carrying membrane that is elastically stretchable and contoured to define at least a portion of the shape of the novelty article. The flexible and waterproof display carrying membrane has at least one inner display layer and at least one outer transparent gripping layer disposed over the inner display layer. The inner display layer includes a fabric layer and a graphic design that is formed on a surface of the fabric layer and that is visible through the outer transparent gripping layer.

### BACKGROUND OF THE INVENTION

1. Field of the Invention

The present invention relates generally to novelty articles and, more particularly, to a novelty article having a flexible and waterproof display carrying membrane. The present invention also relates to a method of manufacturing the novelty article, and to an advertising device having the flexible and waterproof display carrying membrane.

2. Background Information

Many sports (e.g., football, baseball, basketball, tennis, golf, and hockey) use sports equipment such as, without limitation, balls, clubs, rackets, and bats that are caught or gripped by the hand. Sports equipment has always been sought after for displaying advertisement of a team name, school name, game sponsors, etc. The sports equipment may have some form of advertisement which can be expensive to apply and/or has a limited durability.

For example, game balls such as, footballs, may have an advertisement in the form of an overlaid graphic layer applied to a portion of the outer surface of the ball. However, the use of the sports equipment affects the durability of the advertisement as this layer fades, chips, peels and/or is scratched over time, particularly when the sports equipment is subjected to and/or used in wet environments. Such an advertisement is also limited to the color variations that can be applied. In many cases, only one or two colors are used. Moreover, the aesthetics of the advertisement can be significantly limited.

Many sports equipment are held, gripped or caught by a player's hands. Thus, much attention has been given to improving a grip of a racket, club, bat, ball, etc. The conventional application of an advertisement, such as a thin film laminated over the outer surface of the sports equipment, can be slippery or counterproductive to the need for a slip-resistant gripping surface. Thus, the advertisement, if applied, is limited in surface area over the outer surface of the sports equipment.

Thus, there is a need for techniques providing novelty articles, such as sports equipment, having a waterproof, scratch-resistant advertisement with an improved gripping surface.

The present invention overcomes many of the disadvantages inherent in conventional novelty articles, such as sports equipment, intended to be gripped, held or caught.

### SUMMARY OF THE INVENTION

It is an object of the present invention to provide a flexible,and waterproof display carrying membrane constructed and arranged to resist the absorption of water for use in wet environments.

Another object of the present invention is to provide a flexible and waterproof display carrying membrane that will retain its shape during prolonged and repeated use.

Another object of the present invention is to provide a flexible and waterproof display carrying membrane constructed and arranged to provide comfort and easy pressure created by the application of a gripping force by a user to a surface of the flexible and waterproof display carrying membrane.

It is another object of the present invention to provide a flexible and waterproof display carrying membrane suitable for use in various novelty articles, including sports equipment and objects or tools with handle structures which are gripped, grasped, or held by a user's hand or fingers.

It is yet another object of the present invention to provide a novelty article having a flexible and waterproof display carrying membrane which is relatively easy and economical to manufacture.

Yet another object of the present invention to provide an advertising device having a flexible and waterproof display carrying membrane which is relatively easy and economical to manufacture.

The foregoing and other objects of the present invention are carried out by a novelty article comprising a flexible and waterproof display carrying membrane that is elastically stretchable and contoured to define at least a portion of the shape of the novelty article. The flexible and waterproof display carrying membrane has at least one inner display layer and at least one outer transparent gripping layer disposed over the inner display layer. The inner display layer includes a fabric layer and a graphic design that is formed on a surface of the fabric layer and that is visible through the outer transparent gripping layer.

The novelty article preferably comprises a base around which the display carrying membrane is disposed to provide the contour for the novelty article's shape or portion thereof. The outer transparent gripping layer of the display carrying membrane is preferably made of a transparent thermoplastic elastomer and has an outer surface that is slip resistant.

In another aspect, the present invention is directed to a waterproof game ball having separate elastically stretchable panels connected and sealed together along marginal edge portions thereof by stitching extending along stitch lines to define a shell. Each of the elastically stretchable panels has at least one inner display layer and at least one outer transparent gripping layer disposed over the inner display layer. The inner display layer includes a fabric layer and a graphic design that is formed on a surface of the fabric layer and that is visible through the outer transparent gripping layer. An inflatable bladder is disposed within the shell and is inflatable with air to expand the shell. The outer transparent gripping layer of each panel is preferably made of a transparent thermoplastic elastomer.

In yet another aspect, the present invention is a flexible and waterproof display carrying membrane having at least one fabric layer and at least one outer transparent gripping layer disposed over a surface of the fabric layer. Advertising indicia is disposed on the surface of the fabric layer and is visible through the outer transparent gripping layer.

Additional objects and aspects will become more readily apparent from the detailed description, particularly when taken together with the appended drawings.

### BRIEF DESCRIPTION OF THE DRAWINGS

The foregoing summary, as well as the following detailed description of preferred embodiments of the invention, will be better understood when read in conjunction with the accompanying drawings. For the purpose of illustrating the invention, there is shown in the drawings embodiments which are presently preferred. It should be understood, however, that the invention is not limited to the precise arrangement and instrumentalities shown. In the drawings:

FIG. 1 is a perspective view of a novelty article which is constructed and arranged as a waterproof game ball according to one embodiment of the present invention;

FIG. 2 is top view of the novelty article of FIG. 1 with portions removed to illustrate the internal construction thereof;

FIG. 3 is a sectional view taken in the direction of line 3-3 of FIG. 1;

FIG. 4 is an enlarged fragmentary view of a portion of the novelty article in FIG. 1 showing two of the flexible and waterproof display carrying membranes prior to sealing;

FIG. 5 is a top flat view of an outer transparent gripping layer;

FIG. 6A is an exploded view of the graphic design and fabric layer for forming an inner display layer of the flexible and waterproof display carrying membrane;

FIG. 6B is a view of the inner display layer of the flexible and waterproof display carrying membrane;

FIG. 6C is an exploded view of the inner display layer and an outer transparent gripping layer of the flexible and waterproof display carrying membrane;

FIG. 6D is a view of the circled section in FIG. 2;

FIG. 7 is a flow chart of a process for forming the flexible and waterproof display carrying membrane;

FIG. 8 is an enlarged partial top view of the flexible and waterproof display carrying membrane sheet with a portion of an outer transparent gripping layer removed to illustrate transparency;

FIG. 9 is a top view of a novelty article constructed and arranged as a waterproof game ball according to another embodiment of the present invention;

FIG. 10A is a top view of a novelty article constructed and arranged as a flying disc according to another embodiment of the present invention;

FIG. 10B is a top perspective view of the novelty article of FIG. 10A with a portion removed to illustrate the internal construction thereof;

FIG. 10C is a sectional view taken in the direction of line 10C-10C of FIG. 10A;

FIG. 11A is a rear view of a novelty article constructed as a baseball glove according to another embodiment of the present invention;

FIG. 11B is a front view of the novelty article shown in FIG. 11A;

FIG. 11C is a sectional view taken in the direction of line 11C-11C of FIG. 11A;

FIG. 12 is front view of a novelty article constructed as a lacrosse stick according to another embodiment of the present invention, with a portion of the handle removed to illustrate the internal construction thereof;

FIG. 13 is a partial view of the internal construction of the handle of the novelty article shown in FIG. 12; and

FIG. 14 is view of a novelty article constructed as a bat according to another embodiment of the present invention, with a portion of the bat removed to illustrate the internal construction thereof.

### DETAILED DESCRIPTION OF THE PREFERRED EMBODIMENTS

While this invention is susceptible of embodiments in many different forms, this specification and the accompanying drawings disclose some examples of the use of the invention. The invention is not intended to be limited to the embodiments so described, and the scope of the invention will be pointed out in the appended claims.

The novelty article according to one aspect of the present invention is described below with a specific application to a game ball in the form of a football. However, it will be appreciated by those of ordinary skill in the art that the present invention is also well adapted for other types of game balls, such as, for example, soccer balls, baseballs, softballs, basketballs and volleyballs. The novelty article according to another aspect of the present invention is adapted for sports equipment, hand-held articles (e.g., tools), novelty articles with handles and the like. The novelty article according to a further aspect of the present invention is an advertising device.

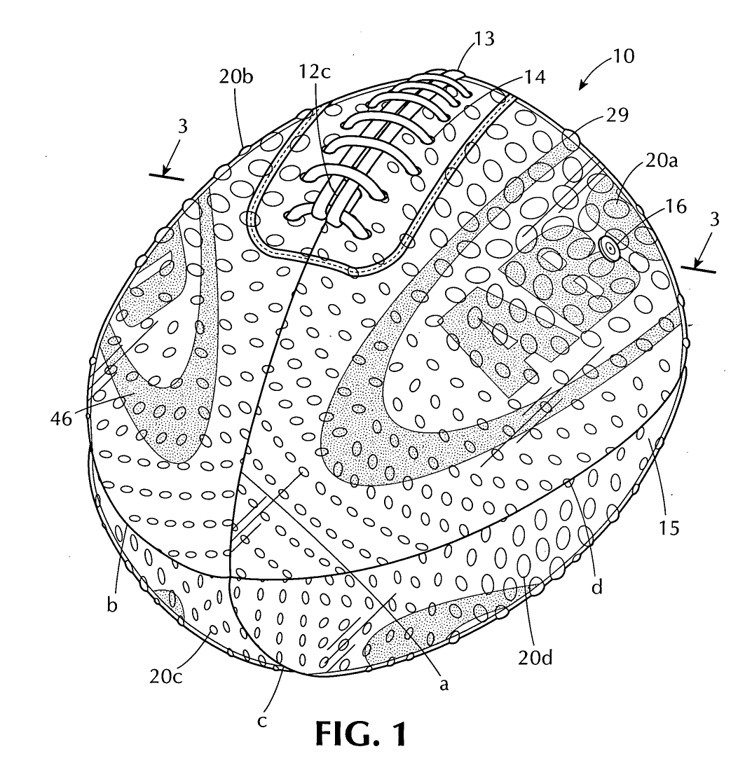

Referring now to the drawings in detail, wherein like numerals are used to indicate like elements throughout, there is shown in FIGS. 1-6D an embodiment of a novelty article which is constructed and arranged as a waterproof game ball, generally designated at 10, according to the present invention. The waterproof game ball 10 has a generally oval configuration having an outer surface, a lengthwise axis A, two opposite ends 52a, 52b, and a maximum diameter midway between the ends, thereby replicating the appearance of a regulation football. The waterproof game ball 10 has a bladder 11 in the form of a flexible, inflatable bag, and an inflation valve 16 projecting outwardly therefrom. The bladder 11 has a generally oval configuration and is adapted to be filled with air through the inflation valve 16. The preferred material for the bladder 11 is butyl rubber or latex. Other suitable materials include, but are not limited to, natural rubber, mixes of butyl rubber and natural rubber polyurethane.

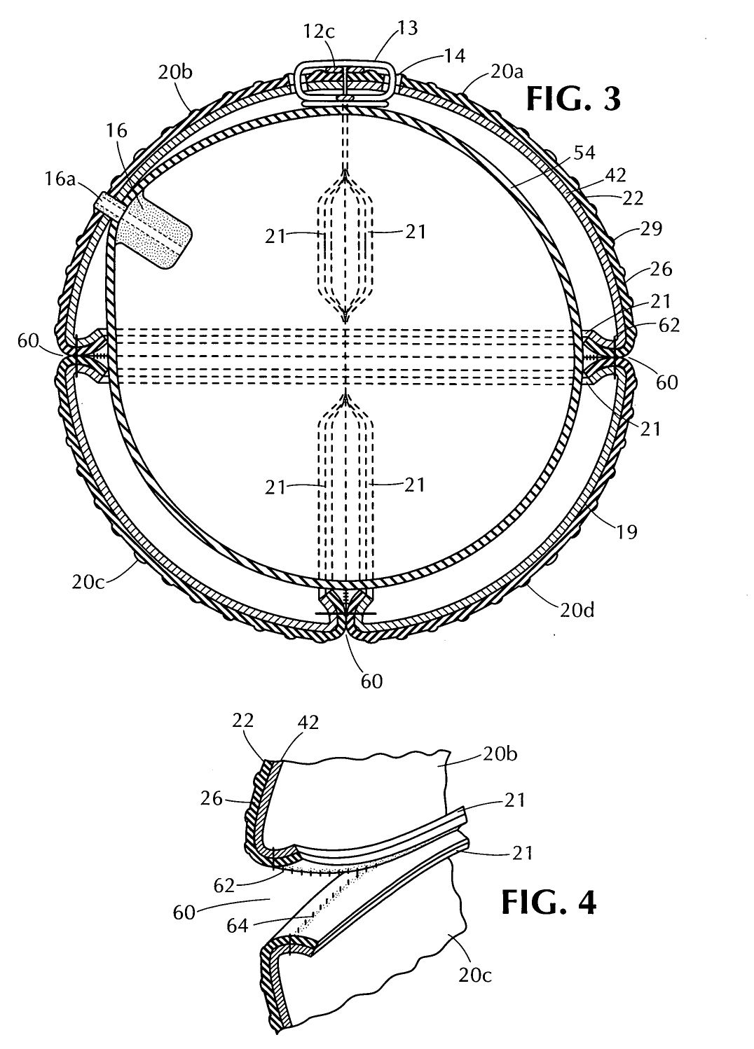

An elastically stretchable outer casing or shell 15 surrounds the bladder 11 and forms a display carrying membrane 19 constructed of four separate substantially identical elastically stretchable flexible panels or display carrying membrane sections 20a, 20b, 20c and 20d sealed together along marginal edge portions 21 to define four equally spaced seams a, b, c and d extending the length of the waterproof game ball 10. More specifically, as shown in FIG. 3, the display carrying membrane sections 20a and 20b are sealed together at their marginal edge portions to form seam a, display carrying membrane sections 20a and 20d are sealed together at their marginal edge portions to form seam b, display carrying membrane sections 20d and 20c are sealed together at their marginal edge portions to form seam c, and display carrying membrane sections 20c and 20b are sealed together at their marginal edge portions to form seam d. In this embodiment, each of the display carrying membrane sections 20a-20d has the configuration of a quadrant of an oval, and when the quadrant panels are sealed together along the respective marginal edge portions thereof, they jointly create the shell for receiving the bladder 11. As shown in FIG. 3, the marginal edge portions protrude from seams a, b, c and d, extend inwardly into the shell of the waterproof gameball 10, and are in contact with the inflated bladder 11. By this construction, the bladder 11 functions as a base by which the display carrying membrane 19 of the waterproof game ball 10 achieves a generally smooth oval configuration which substantially replicates the appearance, texture and surface features of a regulation football. The inflation valve 16 of the bladder 11 is integrally connected to the display carrying membrane section 20b of the display carrying membrane 10 so that a normally-closed air passage 16a of the inflation valve communicates with the outer surface of the waterproof game ball 10 to enable filling of the bladder 11 with air by means of a handheld pump.

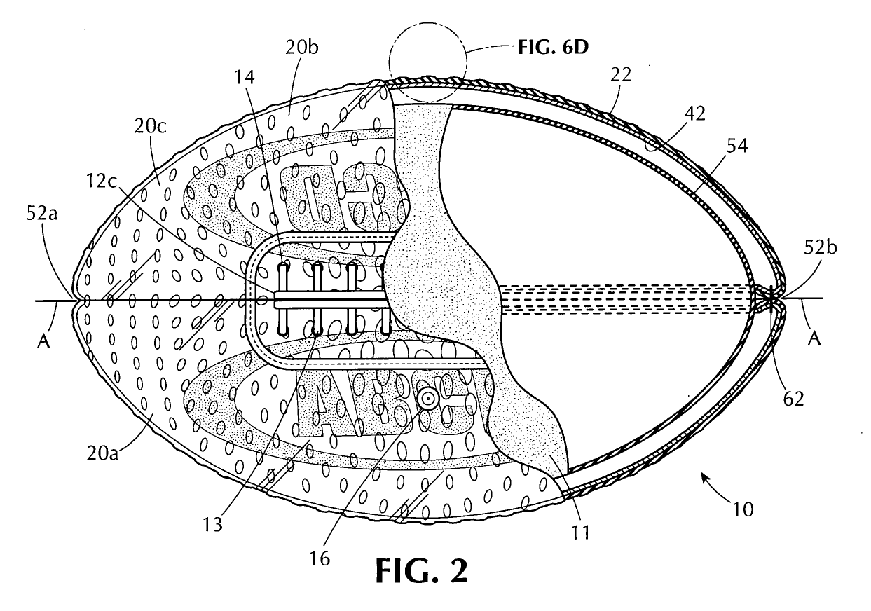

Referring to FIGS. 1 and 2, the display carrying membrane sections 20a and 20b are sealed together to define a gap 12c extending lengthwise along a central portion of the waterproof game ball 10 to enable insertion of the bladder 11 during assembly of the waterproof game ball 10. The display carrying membrane sections 20a and 20b are provided with holes 14 extending along the gap 12c. Lacing 13 made of a plastic or other suitable material extends through the holes 14, crossing the gap 12c, and ties the display carrying membrane sections 20a and 20b together in a waterproof manner to prevent exposure of the bladder 11 to the outside of the waterproof game ball 10 and to substantially totally prevent liquid from entering the interior of the waterproof game ball 10.

The display carrying membrane sections 20a-20d are sealed by a sewing process along stitch lines 62. Although stitching alone of the marginal edge portions of the display carrying membrane sections 20a-20d is usually sufficient to keep water out of the interior of the waterproof game ball 10, additional means may be provided for further sealing the display carrying membrane sections 20a-20d in a waterproof manner. Accordingly, as shown in FIG. 4, the marginal edge portions of the display carrying membrane sections 20a-20d are heat sealed along a seam denoted at 60 using a suitable adhesive 64, for example, thermoplastics synthetic resin adhesives or thermal setting synthetic resin adhesives. However, it is understood by those skilled in the art that other suitable means may be used for further waterproof sealing the stitched marginal edge portions of the display carrying membrane sections 20a-20d. For example, after the stitching process, the marginal edge portions may be sealed with a seam sealer, waterproof tape or the like.

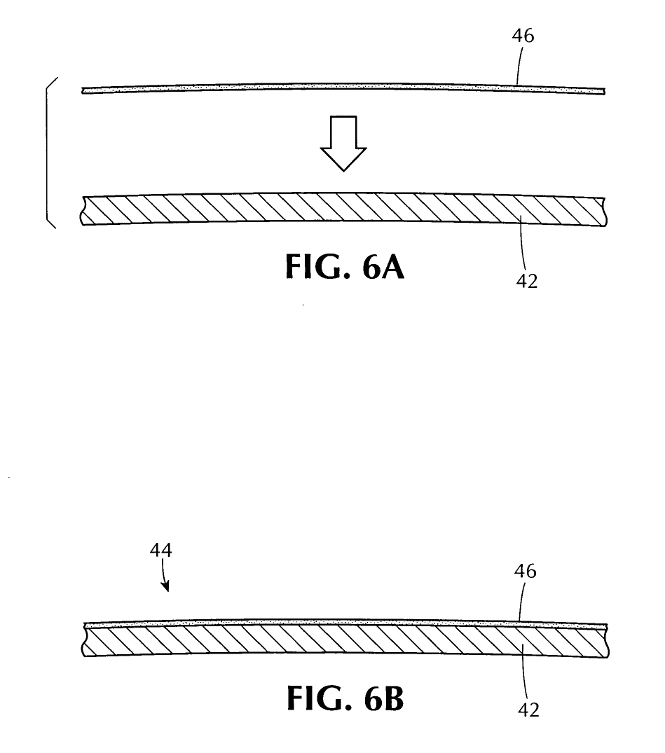

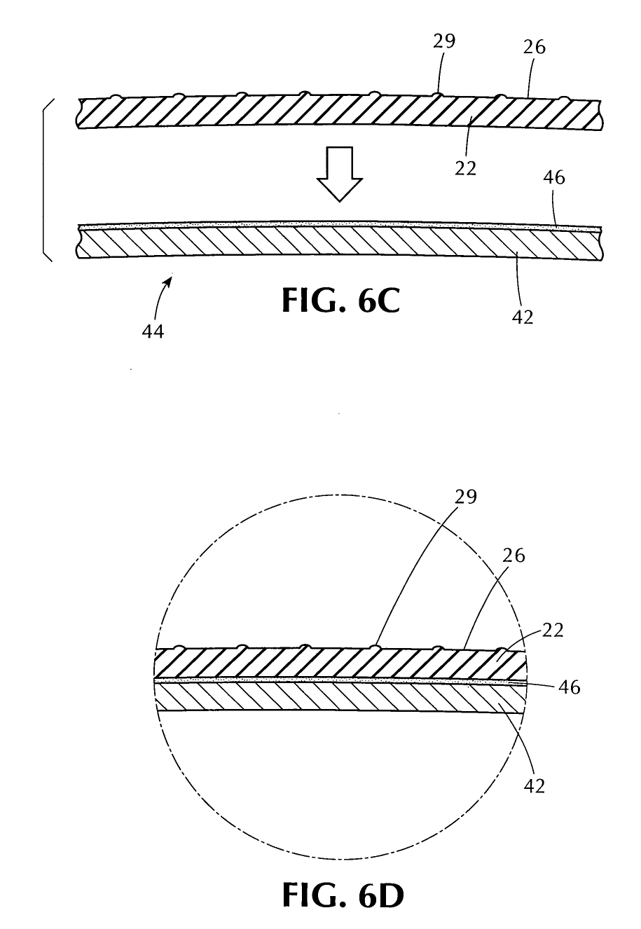

According to this embodiment, each of the display carrying membrane sections 20a-20d is of multi-layer construction and is formed of an inner display layer 44 and an outer transparent gripping layer 22 of substantially water-impervious material disposed on a major surface of the inner display layer 44 and defining the outer surface of the waterproof game ball 10. As shown in FIGS. 6A-6D, the inner display layer 44 includes a graphic design 46 (e.g., denoted in FIGS. 1-2 by ABC within a ring-shaped design) adapted to be printed, painted, laminated or applied to an underlying layer 42 composed of a fabric material. The graphic design 46 may cover the entire surface of the underlying fabric layer 42 or cover portions of the fabric layer 42. Hence, the inner display layer 44 when viewed through the outer transparent gripping layer 22 may show only the graphic design 46 or both the graphic design 46 and portions of the surface of the fabric layer 42.

Each of the fabric layers 42 is preferably made of a thin layer of an elastically stretchable flexible material, such as nylon. Other suitable materials for the fabric layers 42 which exhibit the above properties include, but are not limited to, lycra, polyester and fleece. The fabric layers 42 may have multiple colors or a single solid color. To add to the entertaining aesthetics of the novelty article 10, the color of the fabric material may be bright or bold and may be a coordinating color for a group of novelty articles intended to be used or matched together. The graphic design 46 may include an advertisement, a company name, a team name, logo, alone or in combination with emblems, graphic art, etc. The graphic design may be computer generated.

Preferably, a single piece of a clear (i.e., transparent) thermoplastic elastomer (TPE), such as thermoplastic rubber, is used as the transparent gripping layer 22 of each of the display carrying membrane sections 20a-20d. TPEs are a class of copolymers or a physical mix of polymers (usually a plastic and a rubber) which consist of materials with both thermoplastic and elastomeric properties. TPEs can be repeatedly stretched without permanently deforming the shape of the part, exhibit excellent waterproof properties, and are associated with high weather, ozone, chemical and ultraviolet (UV) resistance and high processability, colorability and adhesion. Unlike rubber-like elastomers, TPEs do not require curing or vulcanization, as they are true thermoplastics. TPEs may be processed by conventional thermoplastic techniques such as injection molding, extrusion and blow molding.

Moreover, TPEs have the potential to be recyclable since they can be molded, extruded and reused like plastics, but they have typical elastic properties of rubbers which are not recyclable owing to their thermosetting characteristics. TPEs also require little or no compounding, with no need to add reinforcing agents, stabilizers or cure systems. Hence, batch-to-batch variations in weighting and metering components are absent, leading to improved consistency in both raw materials and fabricated articles. TPEs can be easily colored by most types of dyes. Additionally, TPEs consume less energy and closer and more economical control of product quality is possible.

Thus, among other advantageous properties described above, TPE is a material which not only exhibits excellent waterproof properties, but also has a desirable flexible property which permits it to be repeatedly elastically deformed without damage or permanent deformation while providing structural integrity to the waterproof game ball 10. However, it is understood by those skilled in the art that other clear (i.e., transparent) elastomeric materials exhibiting the above properties may be used for the transparent gripping layers 22 of the display carrying membrane sections 29a-20d.

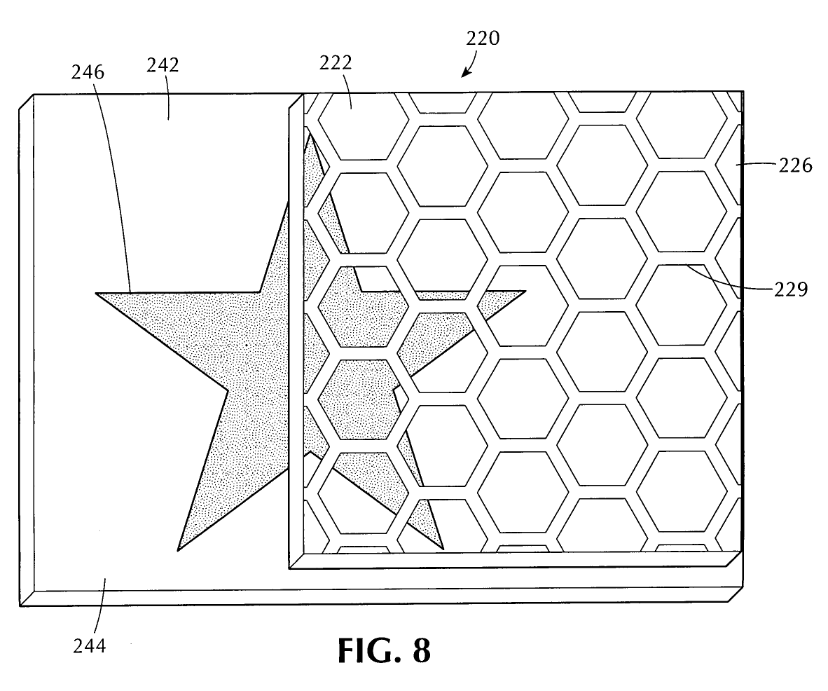

Each of the display carrying membrane sections 20a-20d has an outer surface 26 constructed with a slip-resistant pattern 29. The slip-resistant pattern 29 includes, without limitation bumps (FIGS. 1, 2 and 5) or a honeycomb pattern (FIGS. 8, 9, 10A, 11A, 12 and 14). The bumps may be raised semi-circular members, raised semi-elliptical members or other geometric shapes. The slip-resistant pattern 29 may also include grooves, ribs, a lattice pattern or a pattern with a combination of bumps, grooves, ribs, lattice or honeycombs.

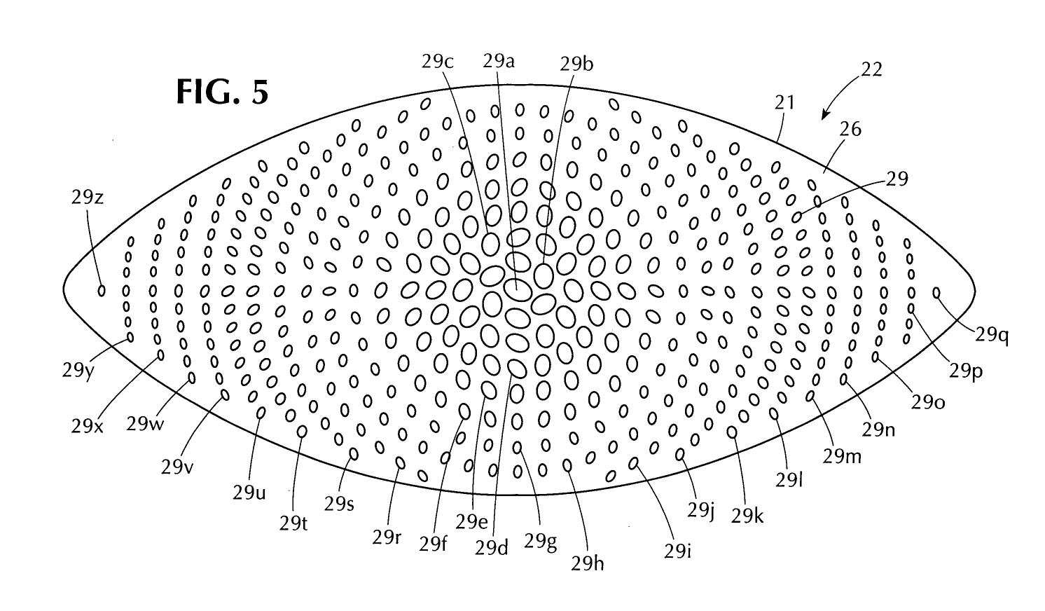

FIG. 5 is a top flat view of the outer transparent gripping layer 22 having an oval shape for the waterproof game ball 10. The slip-resistant pattern 29 on the outer surface 26 includes a center bump 29a positioned in the center of the membrane section 20. The center bump 29a is surrounded by a plurality of bumps 29b arranged in a generally circular shape. The circle of the plurality of bumps 29b is surrounded by a circle of a plurality of bumps 29c. The circle of the plurality of bumps 29c is surrounded by a circle of a plurality of bumps 29d. The circle of the plurality of bumps 29d is surrounded by a circle of a plurality of bumps 29e. The circle of the plurality of bumps 29e is surrounded by a circle of a plurality of bumps 29f. The circle of the plurality of bumps 29f is surrounded by a circle of a plurality of bumps 29g. The circle of the plurality of bumps 29g is surrounded by a circle of a plurality of bumps 29h. In one aspect of the invention, the sizes of the bumps from the center to the circle of the plurality of bumps 29h are gradually decreasing. Furthermore, the bumps may be elliptical in shape. Thus, alternating circles may offset the arrangement of the bumps.

On a right side of the circle of the plurality of bumps 29h, a series of spaced-apart, arched-shaped bands of bumps 29i, 29j, 29k, 29l, 29m, 29n, 29o, 29p and 29q extends to the right distal end of the membrane section 20. On a left side of the circle of the plurality of bumps 29h, a series of spaced-apart, arched-shaped bands of bumps 29r, 29s, 29t, 29u, 29v, 29w, 29x, 29y, and 29z extends to the left distal end.

Thus, the plurality of flexible and waterproof display carrying membrane sections 20a-20d are sewn at seams a, b, c and d and sealed together as described above to assemble the waterproof display carrying membrane 19 that covers the novelty article's base 11. The shape of the display carrying membrane 19 is a function of the size and shape (contour) intended for the novelty article or portion thereof. The outer surface 26 of the display carrying membrane 19 has the slip-resistant pattern 29 which may be distributed over the entire outer surface. The graphic design 46 is applied or embedded over the inner display layer 44 of one or more of the display carrying membrane sections 20a-20d. Thus, each membrane section may not have the same graphic design or portion thereof. However, the assembled waterproof display carrying membrane 19 has the complete graphic design 46 defining the graphic art, advertisement, company name, etc.

The outer surface 26 of the outer transparent gripping layers 22 is elastic, tacky and durable. Thus, the waterproof display carrying membrane 19 is well suited for novelty articles that are used in wet environments, such as for use in water sports. More specifically, during use in wet environments, each of the outer transparent gripping layers 22, which define the outer surface of the novelty article, is water-impervious. Thus the novelty article may be used in wet environments without damaging the novelty article or adversely affecting the flexibility and usability of the novelty article. Nonetheless, the tacky property may be desirable at times other than during use of the novelty article in wet environments. For example, when forming the novelty article as a game ball as described above, the tacky property of the outer transparent gripping layers 22 permits the game ball to be easily caught with one hand. Thus, the tacky property makes the game ball easier to catch and throw.

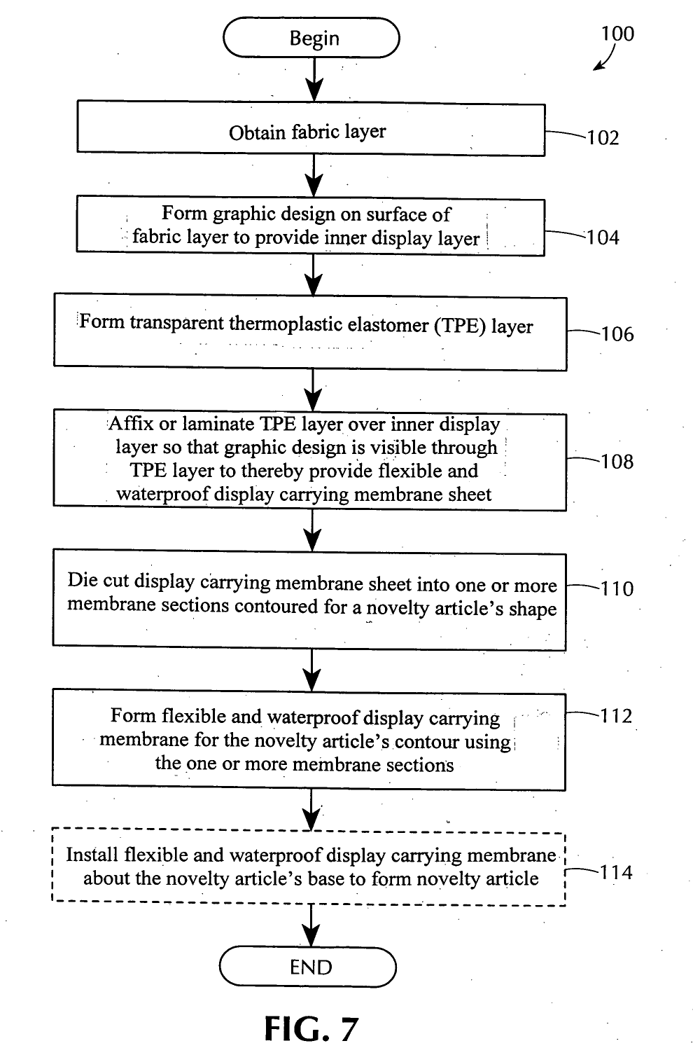

FIG. 7 is a flow chart of a process for forming the flexible and waterproof display carrying membrane 19 and a novelty article having the display carrying membrane 19. The process 100 will also be described in relation to FIGS. 6A-6D. The process 100 begins with block 102 where the fabric layer 42 is obtained. Block 102 is followed by block 104 where a graphic design 46 is applied or formed on an upper (top) main surface of the fabric layer 42, as best seen in FIGS. 6A and 6B. This forms the inner display layer 44. Block 104 is followed by block 106 where the transparent thermoplastic elastomer (TPE) layer with a slip-resistant pattern is formed. The transparent TPE layer serves as the outer transparent gripping layer 22. Block 106 is followed by block 108 where the transparent TPE 22 is laminated or affixed over the inner display layer 44 so that the graphic design 46 is visible through the transparent TPE 22, thereby forming a flexible and waterproof display carrying membrane sheet, as best seen in FIGS. 6C and 6D. The TPE 22 may be affixed or laminated over the inner display layer 44 by any means known in the art, including but not limited to heat embossing, thermal bonding, ultrasonic welding, and/or adhesive lamination. Block 108 is followed by block 110 where the sheet is die cut into one or more membrane sections contoured for a novelty article shape. For example, the sections 20A, 20B, 20C and 20D are die cut to an appropriate size using a generally oval-shaped pattern. Block 110 is followed by block 112 where the flexible and waterproof display carrying membrane is created for the novelty article contour from the one or more membrane sections. For example, the sections 20A, 20B, 20C and 20D are stitched and heat sealed with an adhesive 64 to complete waterproofing. Block 112 is followed by an optional block 114 shown in phantom. At block 114, for those novelty articles that have a base, the flexible and waterproof display carrying membrane is installed on, over,or around the novelty article's base. For example, in this embodiment the internal bladder 54 is inserted through the gap 12c.

An exemplary process for assembling the game ball 10 using the components described herein is described in U.S. Pat. No. 5,997,422, entitled “WATERPROOF GAME BALL,” which is incorporated herein by reference in its entirety.

FIG. 8 is an enlarged, partial top view of the flexible and waterproof display carrying membrane sheet 220 with a portion of an outer transparent gripping layer 222 removed to illustrate transparency. The outer transparent gripping layer 222 of the membrane sheet 220 has an exemplary honeycomb pattern 229 distributed over its outer surface 226. The inner display layer 244 is comprised of a graphic design 246 applied (painted, printed, etc.) to a top side of a fabric layer 242. The graphic design 246 (denoted by a star) is visible through the outer transparent gripping layer 222. In this example, the graphic design 246 covers only a portion of the top side of the fabric layer 242. Thus, the inner display layer 244 includes both the fabric layer 242 and the graphic design 246. Nonetheless, the top side of the fabric layer 242 may be completely covered and overlaid with a graphic design.

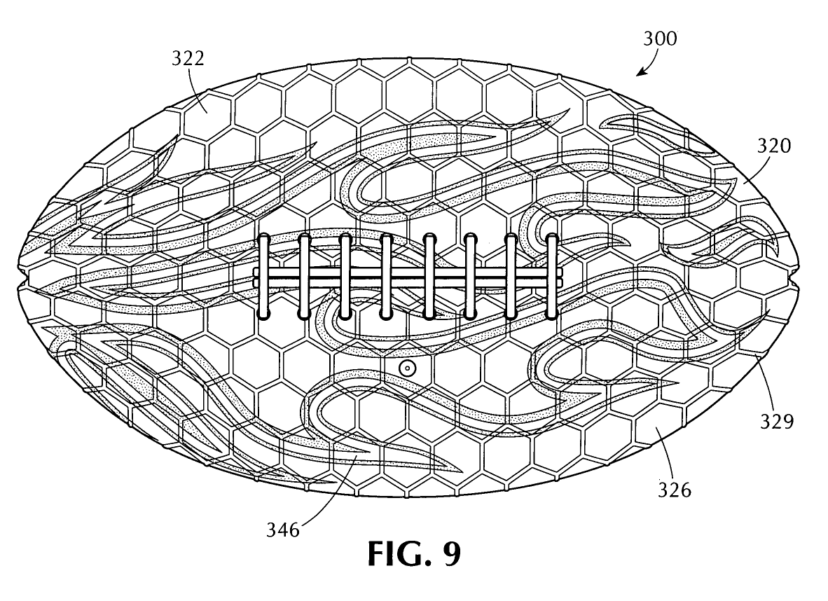

FIG. 9 is a side view of a novelty article 300 constructed and arranged as a waterproof game ball according to another embodiment of the present invention. The novelty article includes a flexible and waterproof display carrying membrane having an outer transparent gripping layer 322. The outer transparent gripping layer 322 has an exemplary honeycomb pattern distributed over its outer surface 326. The inner display layer is visible though the outer transparent gripping layer 322. The graphic design 346 (denoted by flames) is visible through the outer transparent gripping layer 322. The construction of the novelty article 300 is similar to the construction described above for the novelty article 10 of FIGS. 1-4.

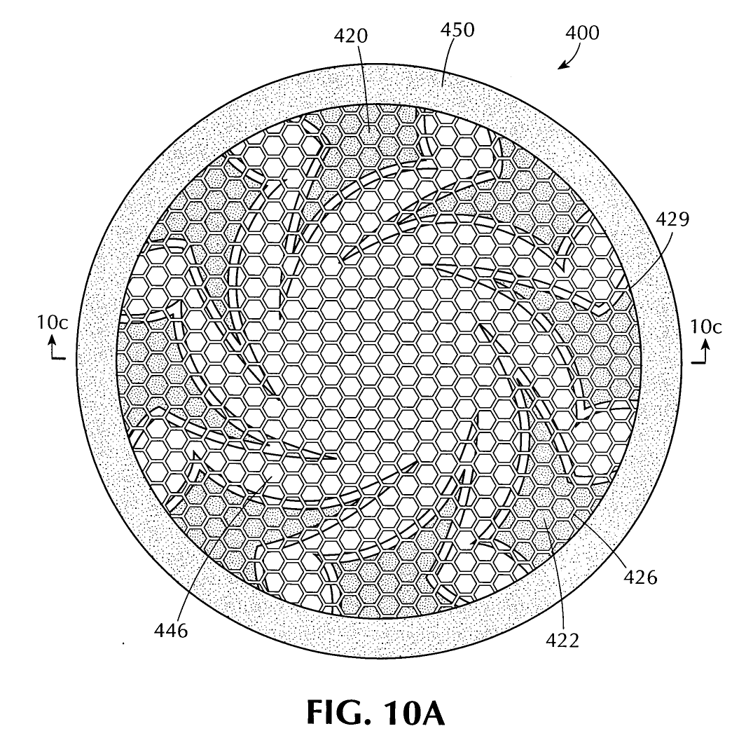

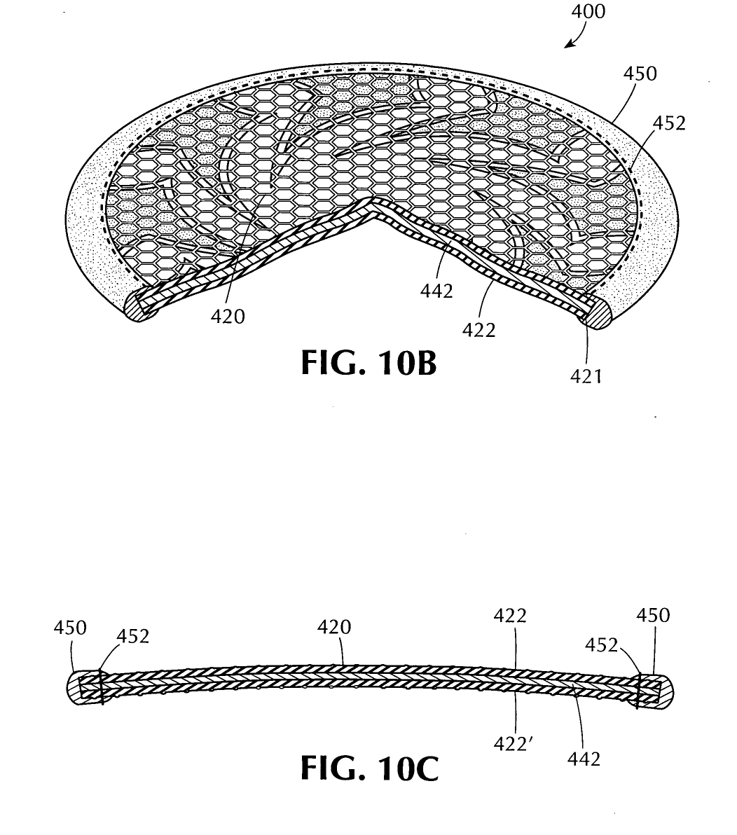

FIG. 10A is a top view of a novelty article 400 constructed and arranged as a flying disc according to another embodiment of the present invention. In the exemplary illustration, the flying disc has a circular shape. The novelty article 400 includes a flexible and waterproof display carrying membrane 420 contoured to the circular shape. The flexible and waterproof display carrying membrane 420 includes an outer transparent gripping layer 422. The outer transparent gripping layer 422 has an exemplary honeycomb pattern 429 distributed over its outer surface 426. The inner display layer is visible though the outer transparent gripping layer 422. The graphic design 446 is visible through the outer transparent gripping layer 422.

FIG. 10B is a top perspective view of the novelty article 400 of FIG. 10A with a portion removed to illustrate the internal construction thereof. The marginal edge 421 is finished, covered or wrapped with at least one waterproofing band or binding strip 450. The band or binding strip 450 is wrapped and stitched via stitches 452 to the perimeter marginal edge 421. The seal between the band or binding strip 450 and marginal edge 421 is preferably waterproofed.

FIG. 10C is a sectional view taken in the direction of line 10C-10C of FIG. 10A. The novelty article 400 is constructed and arranged with a flexible and waterproof display carrying membrane 420 having an outer transparent gripping layer 422. The novelty article 400 includes a second outer transparent gripping layer 422′ which may be essentially identical to the outer transparent gripping layer 422. The fabric layer 442 may be directly laminated or affixed to an inner side of the outer transparent gripping layer 422′. Nonetheless, the second side of the fabric layer 442 may have a graphic design applied thereto to provide a double-sided flexible and waterproof display carrying membrane,420. When assembled as shown in FIGS. 10A-10C, the outer transparent gripping layer and the fabric layer are superimposed over one another to form a generally disc-shaped body.

An exemplary process for assembling the flying disc using the components described herein is described in U.S. Pat. No. 6,174,214, entitled “FLEXIBLE WATERPROOF FLYING DISC AND METHOD OF MANUFACTURE THEREOF,” which is incorporated herein by reference in its entirety.

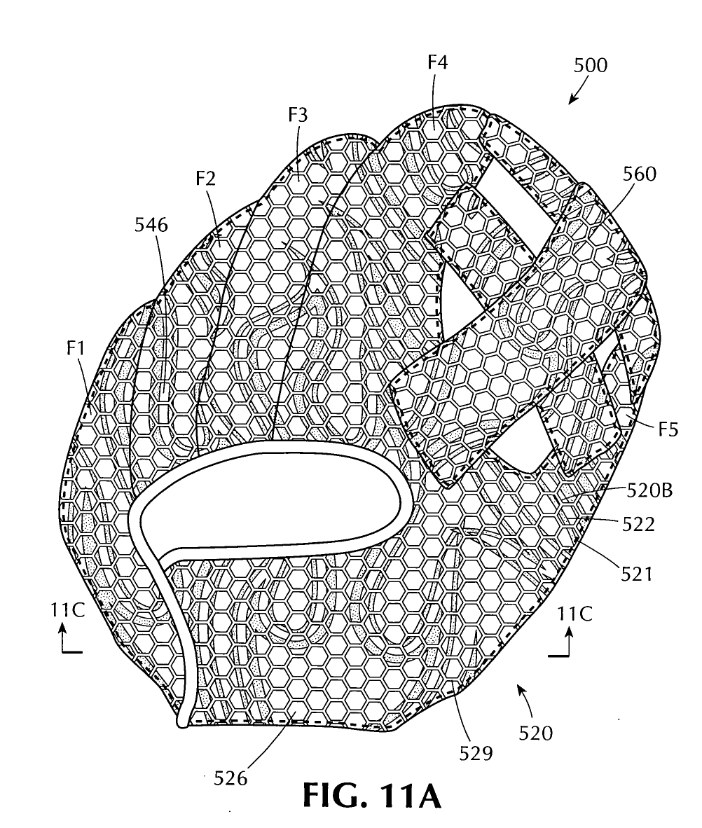

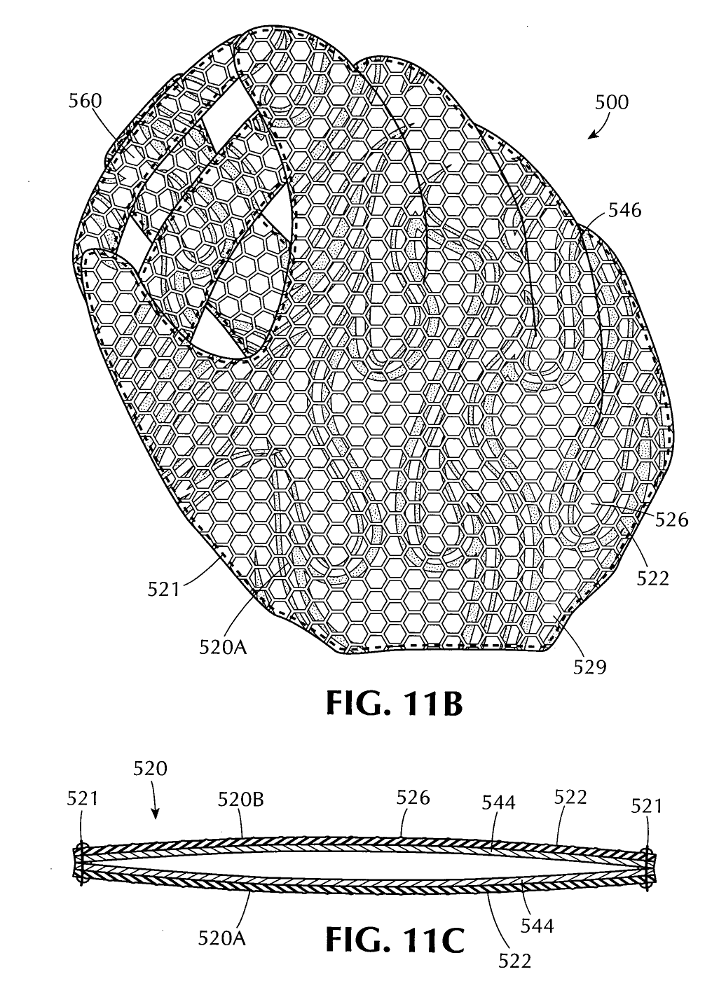

FIG. 11A is a rear view of a novelty article 500 constructed as a sports glove, baseball glove or hand enclosure. In this embodiment, the novelty article 500 includes a flexible and waterproof display carrying membrane 520 contoured to create a baseball glove contour. The flexible and waterproof display carrying membrane 520 includes an outer transparent gripping layer 522. The outer transparent gripping layer 522 has an exemplary honeycomb pattern 529 distributed over its outer surface 526. The inner display layer 544 has a graphic design 546 (denoted by flames) which is visible though the outer transparent gripping layer 522.

Referring also to FIGS. 11B and 11C, the flexible and waterproof display carrying membrane 520 includes a front flexible and waterproof display carrying membrane section 520A and a rear flexible and waterproof display carrying membrane section 520B (FIG. 11A) sewn via stitches 521 along marginal portions thereof. The front flexible and waterproof display carrying membrane section 520A and rear flexible and waterproof display carrying membrane section 520B are stitched along marginal portions thereof to create designated finger slots, denoted by F1, F2, F3, F4 and F5, within the hand enclosure or baseball glove contour. In one aspect of the invention, the seams are heat sealed and the fabric material of the inner display layer 544 is waterproofed. Like a baseball glove, the novelty article 500 includes a webbing section 560 which webs or affixes the thumb finger slot F5 with a forefinger slot F4.

An exemplary process for assembling the sports glove using the components described herein is described in U.S. Pat. No. 5,706,519, entitled “WATERPROOF SPORTS GLOVE,” which is incorporated herein by reference in its entirety.

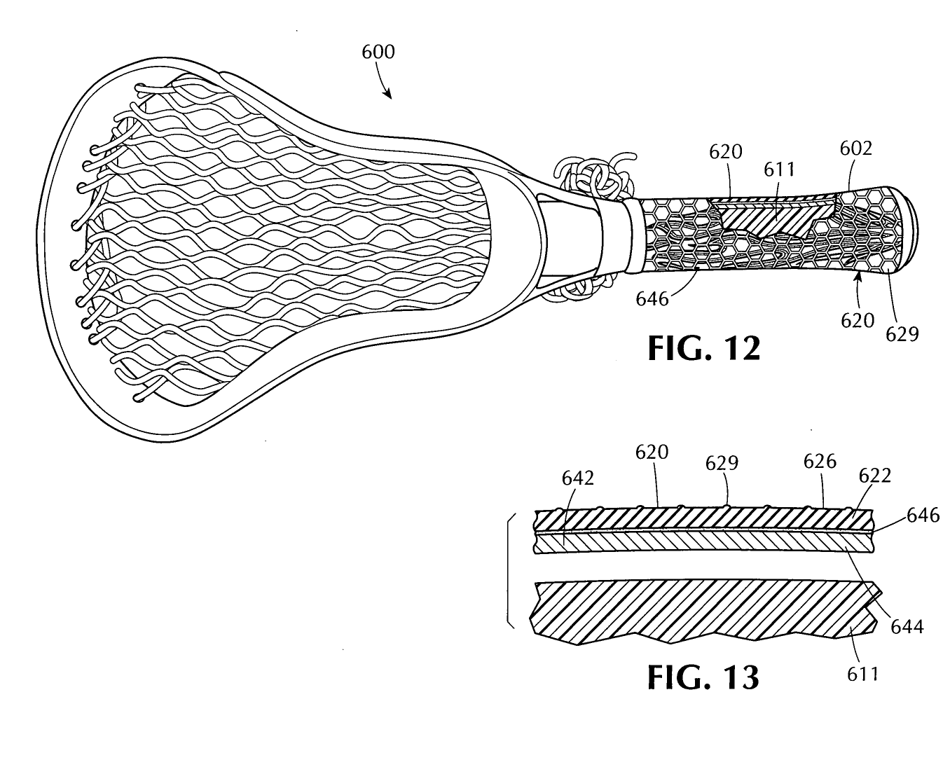

FIG. 12 is front view of a novelty article 600 constructed as a strung head stick, such as a lacrosse stick, with a portion of a handle removed to illustrate the internal construction thereof. The novelty article 600 has a handle portion 602 having a handle base 611. The handle base 611 is covered by a flexible and waterproof display carrying membrane 620 having an outer transparent gripping layer 622. The outer transparent gripping layer 622 has an exemplary honeycomb pattern 629 distributed over its outer surface 626. The inner display layer 644 is visible through the outer transparent gripping layer 622. The graphic design 646 (denoted by flames) is visible through the outer transparent gripping layer 622. The inner display layer 644 includes the graphic design 646 overlaid onto a fabric layer 642, as best seen in FIG. 13.

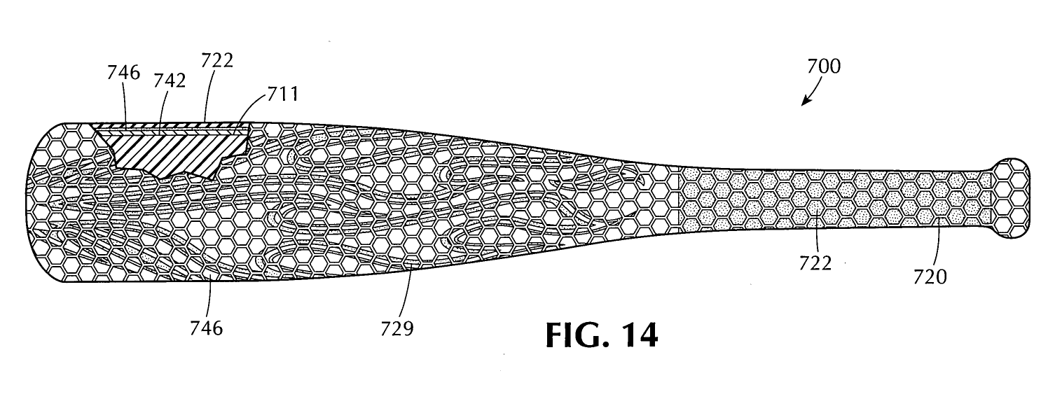

FIG. 14 is view of a novelty article 700 constructed as a bat with a portion removed to illustrate the internal construction thereof. The novelty article 700 includes a flexible and waterproof display carrying membrane 720 having an outer transparent gripping layer 722. The outer transparent gripping layer 722 has an exemplary honeycomb pattern 729 distributed over its outer surface 726. The inner display layer 744 is applied over a fabric layer 742 and is visible though the outer transparent gripping layer 722. The graphic design 746 (denoted by flames) is visible through the outer transparent gripping layer 722. The novelty article 700 has a bat base 711 contoured to resemble a baseball bat. The bat base 711 is covered by the flexible and waterproof display carrying membrane 720 shaped to track the bat contour of the bat base 711.

It is appreciated that the base, which is surrounded by the display carrying membrane, for the novelty article according to the present invention may be flexible, resilient and/or rigid. The size and shape of the base defines the size, function and operation of the novelty article. For example, if the display carrying membrane is applied to a handle, such as shown in FIG. 12, then the handle would provide a rigid or semi-rigid structure for installing the display carrying membrane therearound. In another example, if the novelty article is a game ball, as shown in FIG. 1, the base is an internal bladder which, when inflated, imparts the shape to the game ball. Thus, when the novelty article is a football, as shown in FIG. 1, the body of the game ball has a generally oval configuration corresponding to the oval shape of the internal bladder. Likewise, if the novelty article is a volleyball, the internal bladder would have a generally spherical shape. As can be appreciated, to describe each and every type of novelty article and corresponding shape is prohibitive.

The waterproof novelty articles according to the present invention as generally described and illustrated herein could be constructed using any number of acceptable methods in a wide variety of different configurations. For example, the number of membrane sections for the membrane of the waterproof game ball may be less than or greater than four and of different dimensions and configurations, and may be assembled to configure game balls other than a football such as, for example, baseballs, softballs, basketballs and volleyballs. Thus, the foregoing detailed description of the presently preferred embodiments of the invention is only illustrative of the nature of the invention and is not intended to limit the scope thereof.

Moreover, the inventive novelty articles, which may be manufactured in any size and weight, are highly durable and resistant to structural or performance degradation. Thus the waterproof property of the novelty articles according to the present invention is particularly well-adapted for use in wet environments without damaging or adversely affecting the flexibility and usability of the novelty article.

The novelty article may include objects, tools, and sports equipment with elongated handle structures which are gripped, grasped, or held by a user's hand or fingers. The outer transparent gripping layer is constructed and arranged to provide comfort and easy pressure created by the application of a gripping force to the outer surface of the novelty article (e.g., game ball, flying disc, sports glove, handle structure) by a user.

The outer transparent gripping layer with the visible inner display layer may also be applied to those articles with handles other than described herein. For example, the outer transparent gripping layer with the visible inner display layer may be applied to handles or handlebars of bicycles, motorcycles, motorized all-terrain vehicles, etc. Furthermore, the display carrying membrane may be configured to provide shock absorption during use of the novelty article. In this regard, TPE is compressible and has shock absorption properties so that impact forces of the novelty article during use are reduced. For example, the user's hands may be insulated from impact forces during use of the sports glove according to the present invention.

The novelty article of the present invention is also applicable as an advertising device. For example, the graphic designs described above in connection with the various embodiments may comprise advertising indicia, such as a company name or logo and/or an advertising message. The visual representations of the such graphic designs add desired decorative and aesthetic effects to the novelty article for attracting attention, which is particularly advantageous when the novelty article is used as an advertising or promotional item.

From the foregoing description, it can be seen that the present invention is directed to an improved novelty article having a flexible and waterproof display carrying membrane and to an improved method of manufacturing the display carrying membrane and novelty article having the display carrying membrane. It will be appreciated by those skilled in the art that obvious changes can be made to the embodiments described in the foregoing description without departing from the broad inventive concept thereof. It is understood, therefore, that this invention is not limited to the particular embodiments disclosed, but is intended to cover all obvious modifications thereof which are within the scope and the spirit of the invention as defined by the appended claims.

I claim:

1. A novelty article comprising: a flexible and waterproof display carrying membrane that is elastically stretchable and contoured to define at least a portion of the shape of the novelty article, the flexible and waterproof display carrying membrane having at least one inner display layer and at least one outer transparent gripping layer disposed over the inner display layer, the inner display layer including a fabric layer and a graphic design that is formed on a surface of the fabric layer and that is visible through the outer transparent gripping layer.

2. A novelty article according to claim 1; further comprising a base around which the display carrying membrane is disposed to provide the contour for the novelty article's shape or portion thereof.

3. A novelty article according to claim 1; wherein the outer transparent gripping layer is made of a transparent thermoplastic elastomer.

4. A novelty article according to claim 1; wherein the outer transparent gripping layer comprises an outer surface having tacky properties.

5. A novelty article according to claim 1; wherein the outer transparent gripping layer comprises an outer slip-resistant surface.

6. A novelty article according to claim 5; wherein the outer slip-resistant surface comprises a plurality of raised bumps.

7. A novelty article according to claim 5; wherein the outer slip-resistant surface has a honeycomb pattern.

8. A novelty article according to claim 1; further comprising an inflatable bladder disposed within the display carrying membrane and being inflatable with air to expand the display carrying membrane and form the novelty article's shape or portion thereof.

9. A novelty article according to claim 8; wherein the outer transparent gripping layer is made of a transparent thermoplastic elastomer.

10. A novelty article according to claim 8; wherein the outer transparent gripping layer comprises an outer surface having tacky properties.

11. A novelty article according to claim 8; wherein the outer transparent gripping layer comprises an outer slip-resistant surface.

12. A novelty article according to claim 11; wherein the outer slip-resistant surface comprises a plurality of raised bumps.

13. A novelty article according to claim 11; wherein the outer slip-resistant surface has a honeycomb pattern.

14. A novelty article according to claim 1; wherein the at least one inner display layer includes the graphic design on opposite main surfaces of the fabric layer; and wherein the at least one outer transparent gripping layer comprises two outer transparent gripping layers disposed on the respective opposite main surfaces of the fabric layer so that the graphic design on the opposite main surfaces of the fabric layer is visible through the outer transparent gripping layers.

15. A novelty article according to claim 14; wherein the outer transparent gripping layers and the inner display layer are superimposed over one another to form a generally disc-shaped body; and further comprising at least one binding strip sewn to and around a peripheral edge of the body.

16. A novelty article according to claim 14; wherein each of the outer transparent gripping layers is made of a transparent thermoplastic elastomer.

17. A novelty article according to claim 14; wherein each of the outer transparent gripping layers comprises an outer surface having tacky properties.

18. A novelty article according to claim 14; wherein each of the outer transparent gripping layers comprises an outer slip-resistant surface.

19. A novelty article according to claim 18; wherein each outer slip-resistant surface comprises a plurality of raised bumps.

20. A novelty article according to claim 18; wherein each outer slip-resistant surface has a honeycomb pattern.

21. A novelty article according to claim 1; wherein the flexible and waterproof display carrying membrane comprises (i) a first multi-layer piece of material having the at least one inner display layer as a first inner display layer and the at least one outer transparent gripping layer as a first outer transparent gripping layer, and (ii) a second multi-layer piece of material having a second inner display layer and a second outer transparent gripping layer disposed over the second inner display layer, the second inner display layer including a fabric layer and a graphic design that is formed on a surface of the fabric layer of the second inner display layer and that is visible through the second outer transparent gripping layer.

22. A novelty article according to claim 21; wherein the first and second multi-layer pieces of material are superposed on one another and connected and sealed together along marginal edge portions thereof to define a glove body having an open lower section configured to receive therethrough the hand of a user during use of the glove, the glove body having at least one finger section comprising at least one finger compartment for receiving therein at least one finger of the user's hand.

23. A novelty article according to claim 21; wherein each of the first and second outer transparent gripping layers is made of a transparent thermoplastic elastomer.

24. A novelty article according to claim 21; wherein each of the first and second outer transparent gripping layers comprises an outer surface having tacky properties.

25. A novelty article according to claim 21; wherein each of the first and second outer transparent gripping layers comprises an outer slip-resistant surface.

26. A novelty article according to claim 25; wherein each outer slip-resistant surface comprises a plurality of raised bumps.

27. A novelty article according to claim 25; wherein each outer slip-resistant surface has a honeycomb pattern.

28. A novelty article according to claim 1; further comprising a novelty article's handle having a rigid or semi-rigid structure covered by the flexible and waterproof display carrying membrane.

29. A novelty article according to claim 28; wherein the novelty article is a tool having the novelty article's handle.

30. A novelty article according to claim 28; wherein the novelty article is a sports equipment constructed and arranged to include the novelty article's handle.

31. A novelty article according to claim 30; wherein the sports equipment is a head strung lacrosse game stick.

32. A novelty article according to claim 28; wherein the outer transparent gripping layer of the flexible and waterproof display carrying membrane is made of a transparent thermoplastic elastomer.

33. A novelty article according to claim 1; wherein the graphic design comprises advertising indicia.

34. A novelty article according to claim 1; wherein the graphic design is layered over an entire surface area of the fabric layer.

35. A waterproof game ball comprising:
a plurality of separate elastically stretchable panels connected and sealed together along marginal edge portions thereof by stitching extending along stitch lines to define a shell, each of the elastically stretchable panels having at least one inner display layer and at least one outer transparent gripping layer disposed over the inner display layer, the inner display layer including a fabric layer and a graphic design that is formed on a surface of the fabric layer and that is visible through the outer transparent gripping layer; and
an inflatable bladder disposed within the shell and being inflatable with air to expand the shell.

36. A waterproof game ball according to claim 35; wherein the outer transparent gripping layer is made of a transparent thermoplastic elastomer.

37. A waterproof game ball according to claim 35; wherein the outer transparent gripping layer comprises an outer surface having tacky properties.

38. A waterproof game ball according to claim 35; wherein the outer transparent gripping layer comprises an outer slip-resistant surface.

39. A waterproof game ball according to claim 38; wherein the outer slip-resistant surface comprises a plurality of raised bumps.

40. A waterproof game ball according to claim 38; wherein the outer slip-resistant surface has a honeycomb pattern.

41. A waterproof game ball comprising:
an elastically stretchable display carrying membrane formed of a plurality of flexible panels connected and sealed together along marginal edge portions thereof to define a shell, each of the flexible panels consisting essentially of an inner display layer and an outer transparent gripping layer disposed over the inner display layer, the inner display layer including a fabric layer and a graphic design that is formed on a surface of the fabric layer and that is visible through the outer transparent gripping layer; and
a flexible, inflatable bag disposed within the shell for receiving air to inflate the bag.

42. A waterproof game ball according to claim 41; wherein the outer transparent gripping layer is made of a transparent thermoplastic elastomer.

43. A waterproof game ball according to claim 41; wherein the outer transparent gripping layer comprises an outer surface having tacky properties.

44. A waterproof game ball according to claim 41; wherein the outer transparent gripping layer comprises an outer slip-resistant surface.

45. A waterproof game ball according to claim 44; wherein the outer slip-resistant surface comprises a plurality of raised bumps.

46. A waterproof game ball according to claim 44; wherein the outer slip-resistant surface has a honeycomb pattern.

47. An advertising device comprising:
a flexible and waterproof display carrying membrane comprised of at least one fabric layer and at least one outer transparent gripping layer disposed over a surface of the fabric layer; and
advertising indicia that is disposed on the surface of the fabric layer and that is visible through the outer transparent gripping layer.

48. An advertising device according to claim 47; further comprising a base around which the display carrying membrane is disposed.

49. An advertising device according to claim 47; wherein the outer transparent gripping layer is made of a transparent thermoplastic elastomer.

50. An advertising device according to claim 47; wherein the outer transparent gripping layer comprises an outer surface having tacky properties.

51. An advertising device according to claim 47; wherein the outer transparent gripping layer comprises an outer slip-resistant surface.

52. An advertising device according to claim 51; wherein the outer slip-resistant surface comprises a plurality of raised bumps.

53. An advertising device according to claim 51; wherein the outer slip-resistant surface has a honeycomb pattern.

54. An advertising device according to claim 47; wherein the advertising device is in the form of a game ball.
